(19) United States
(12) Patent Application Publication
(10) Pub. No.: US 2009/0323606 A1
(43) Pub. Date: Dec. 31, 2009

(54) UNEQUAL ERROR PROTECTION FOR A MULTICARRIER TRANSMISSION

(75) Inventors: Rüdiger Halfmann, Otterberg (DE); Matthias Lott, Planegg (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, MUNICH (DE)

(21) Appl. No.: 12/309,109

(22) PCT Filed: Jul. 4, 2007
(86) PCT No.: PCT/EP2007/056770

§ 371 Date: May 26, 2009

(30) Foreign Application Priority Data
Jul. 7, 2006 (EP) 06014131.4

(51) Int. Cl. H04L 1/00; H04L 27/28

(52) U.S. Cl. 370/329; 375/260

(57) ABSTRACT

A method and apparatuses relate to data transmission between at least one first radio station and at least one second radio station in a radio communication system. At least one portion of an available spectrum is allocated for said at least one data transmission, the at least one portion including a number of adjacent sub-carriers; error protection is used for data transmission, wherein the error protecting is distributed in an unequal manner throughout the at least one portion allocated for the at least one data transmission. Data is transmitted upon completion of said error protection.

### CROSS REFERENCE TO RELATED APPLICATIONS

This application is based on and hereby claims priority European Application No. 06014131 filed on Jul. 7, 2006 and International PCT Application No. PCT/EP2007/056770 filed on Jul. 4, 2007, the contents of which are hereby incorporated by reference.

### BACKGROUND OF THE INVENTION

Data transmission in radio communications systems may involve protecting data from the effects caused by interference.

Since the introduction of multi-carrier systems based on OFDM (Orthogonal Frequency Division Multiplexing) in radio communications by 3GPP (3^{rd} Generation Partnership Project), OFDMA (Orthogonal Frequency Division Multiple Access) the access scheme based on OFDM has been proposed as the access scheme to be used within 3GPP LTE (Long Term Evolution). Additionally, OFDMA is one air-interface mode specified in the WiMAX standard, IEEE 802.16, “Part 16: Air Interface for Fixed Broadband Wireless Access”, 24/6/2004, which is also known to also as “scalable OFDMA”.

As illustrated in “Signalling Overhead for ASBA in an MC-CDMA System” by Lott et al., Proceedings of the 11^{th} European Wireless Conference (EW'05), 10-13 Apr., 2005, Nicosia, Cyprus, OFDMA allows for the exploitation of the frequency diversity of a channel in a multi-user environment in an efficient manner, i.e. the best sub-carriers within the available radio spectrum are assigned singly to respective users in order to maximise the overall capacity within the communications system. This however, causes a large amount of signalling to take place between users and APs (access points) as well as increasing the amount of processing that an AP is required to perform.

In order to reduce the signalling traffic required when allocating sub-carriers, a solution has been to allocate adjacent sub-carriers of the available spectrum to individual users for the required connection to an AP, instead of single arbitrary sub-carriers. The allocated adjacent sub-carriers form portions of the available spectrum and are also known as chunks. Within the context of the present application the terms “portion(s)”, “chunk(s)” are used interchangeably to the same effect. In this manner, for example, a radio communications system having a typical available bandwidth of 80 MHz using, for example, an effective number of 1024 sub-carriers with a sub-carrier spacing of 78.125 KHz, can form 32 chunks comprising of 32 sub-carriers.

Nevertheless, the assignment of adjacent sub-carriers, does not resolve the problem caused by ICI (Inter-Carrier Interference). Adjacent sub-carriers of neighbouring chunks continue to affect each other if there is no optimal synchronisation between the allocated chunks. This is all the more pertinent, when in a radio communications system, different chunks are used in neighbouring cells by different APs or neighbouring chunks are used by different users or user equipments (UEs), which cause ICI, which manifests itself as burst errors appearing in the transmission. Consequently, the data transmitted will suffer also from the ICI present and will contain a plurality of errors. APs and UEs therefore require a large amount of processing power in order to protect the data to be transmitted and to remove errors that occur.

A way around this problem and reduce ICI caused by adjacent sub-carriers, is to leave sub-carriers at the edge of each the available spectrum or even at the edge of a chunk unused. This will reduce the generated ICI, as well as reducing the interference suppression required to be performed by filtering techniques at APs and UEs. However, leaving sub-carriers unused, reduces the efficiency and the capacity of the radio communications system.

### SUMMARY

A need therefore exists for a technique that counters the effects interference on transmissions in radio communications systems without reducing the efficiency and capacity of such systems.

The inventors proposed a technique that provides a simple and efficient countering of interference when transmitting a data transmission and at the same time does not reduce in any way the efficiency and the capacity of radio communications systems when using the full amount of available radio spectrum.

The proposed method transmits at least one transmission between at least one first radio station and at least one second radio station in a radio communications system, comprising the steps of:
allocating at least one portion of an available spectrum for the at least one data transmission, the at least one portion comprising of a plurality of adjacent sub-carriers;
error protecting the at least one data transmission, wherein the error protecting is distributed in an unequal manner throughout the at least one portion allocated for the at least one data transmission, and
transmitting the data transmission upon completion of the error protection.

The proposed access point has a transmitter to transmit at least one data transmission between the access node and at least one user equipment in a communications system, wherein:
an allocation unit to allocate at least one portion of an available spectrum for the at least one data transmission, the at least one portion comprising of a plurality of adjacent sub-carriers;
an error protecting unit to error protect the at least one data transmission, wherein said error protecting unit is further adapted to distribute the error protection in an unequal manner throughout the at least one portion allocated for the at least one data transmission, and
a transceiver is adapted to transmit the data transmission upon completion of the error protection.

The inventors propose user equipment having a transmitter to transmit at least one data transmission between the user equipment and at least one access point in a communications system, wherein:
a transceiver to receive a message from the at least one access point over a channel, the message indicating an allocation of at least one portion of an available spectrum for the at least one data transmission, the at least one portion comprising of a plurality of adjacent sub-carriers;
an error protecting unit adapted to error protect the at least one transmission, wherein the error protecting unit is further adapted to distribute the error protection in an unequal manner throughout the at least one portion allocated for the at least one transmission, and
the transceiver is adapted to transmit the transmission upon completion of the error protection.

Further advantages can be seen when the unequal distribution of error protection comprises of implementing a stronger error protection for sub-carriers of the at least one portion lying at an edge of the at least one portion than for sub-carriers lying around a middle part of the at least one portion, thus providing an effective depth of error protection for data over all sub-carriers with a stronger protection around the edges of the allocated portion where more ICI is present, as well as providing protection for sub-carriers around the middle part of the allocated portion where ICI is not that strong.

The error protection applied comprises of a combination of a plurality of coding schemes comprised at least from a rank distance code, a Reed-Solomon code and/or a plurality of modulation schemes comprised at least from the following: a quadrature amplitude modulation scheme, a phase-shift keying modulation scheme, a binary phase-shift keying modulation scheme, thus providing an efficient and thorough error protection. The combination allowing for the depth of protection to be effected and wherein at least two modulation schemes are used at any one time in order to ensure that sub-carriers lying at the edge or around the middle are protected according to the interference present and/or expected. Since interference will be located, with a high probability, at specific sub-carriers the combination of coding and/or modulation schemes allows for the optimisation of the schemes used and thus rendering the system more efficient. Additionally, the combination of coding schemes and/or modulation schemes allows for all sub-carriers to be used for data transmission, thus ensuring that there is no reduction in efficiency as all sub-carriers within the allocated portion are used.

Furthermore, an unequally distributing the transmit power used to transmit the at least one data transmission is also effected over the at least one portion of spectrum allocated in order to further strengthen the transmission and ensure that any interference that might be present is countered by a transmission that can be clearly received. The unequal distribution of the transmit power is effected by assigning a higher transmit power for sub-carriers of the at least one portion lying at an edge of the at least one portion than for sub-carriers lying around a middle part of the at least one portion, thus further protecting the edges from the effects of ICI, but without reducing the protection around the middle.

Additionally, the proposed technique can be implemented in an access point such as a base station, a base station including a base station controller and/or a radio network controller as well as in a user equipment such as a mobile station.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 depicts a radio communications system within which the proposed technique is applicable.

FIGS. 2a and 2b, depict neighbouring sub-carriers causing interference in a radio communications system.

FIG. 3 depicts in a flowchart form the steps implemented by the proposed technique.

FIG. 4 shows the unequal manner distribution of the error protection.

FIG. 5 is a block diagram of an access point showing an arrangement of devices implementing the proposed technique.

FIG. 6 is a block diagram of an user equipment showing an arrangement of devices implementing the proposed technique.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

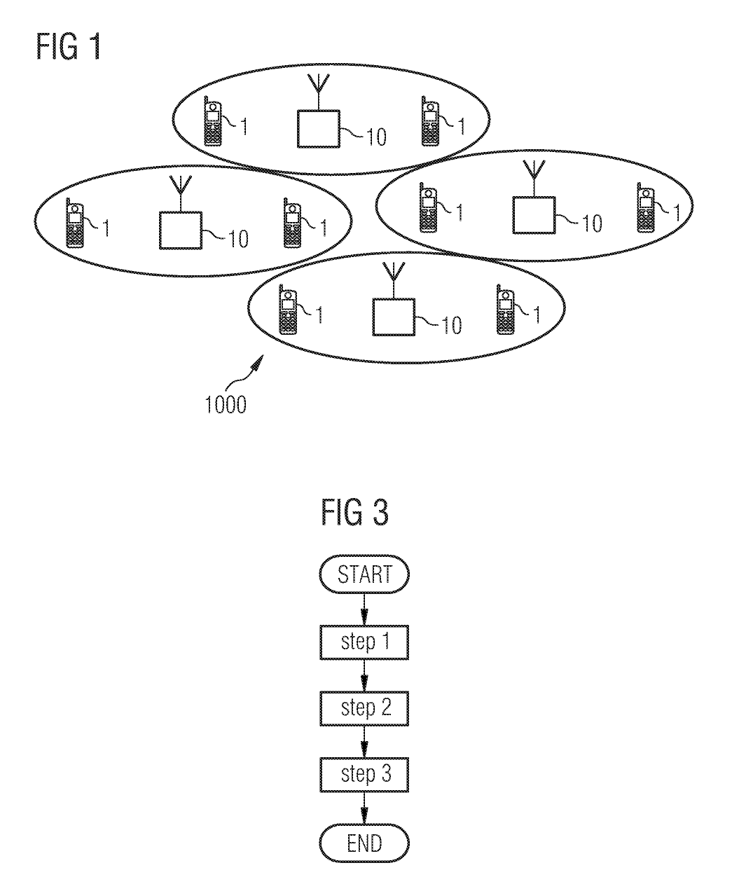

FIG. 1, depicts a radio communications system 1000 comprising of a plurality of first radio station 1 connected via a plurality of second radio station 10 to a PSTN (Public Switched Telephone Network) and/or the Internet. The first radio station 1 can be a user equipment (UE) 1 such as a mobile station, while the second radio station 10 can be an access point 10 which can be one of the following: a base station (BS), a base station (BS) including a base station controller (BSC), a radio network controller (RNC). It is further possible for the second radio station 10 to also be a relay node as well as another mobile station.

In the illustrative example shown in FIG. 1, the first radio station 1 is a user equipment 1 and the second radio station 10 is an access point 10, however a person skilled in the art would be aware of the possibility of using different devices than the ones depicted in FIG. 1 or even to combine the devices depicted in FIG. 1 with other ones. Within radio communications system 1000, a plurality of accessing schemes can be applied in order to allow a user equipment 1 to access an access point 10. Such accessing schemes can be at least one of the following: CDMA (Code Division Multiple Access), TDMA (Time Division Multiple Access), FDMA (Frequency Division Multiple Access), OFDMA (Orthogonal Frequency Division Multiple Access), SDMA (Space Division Multiple Access), CSMA (Carrier Sense Multiple Access), MF-TDMA (Multi-Frequency TDMA), W-CDMA (Wideband-CDMA). In one illustrative example of the proposed technique, OFDMA is at least one such accessing scheme used, however a person skilled in the art would be aware of the possibility to use another accessing scheme or a combination of accessing schemes in radio communications system 1000.

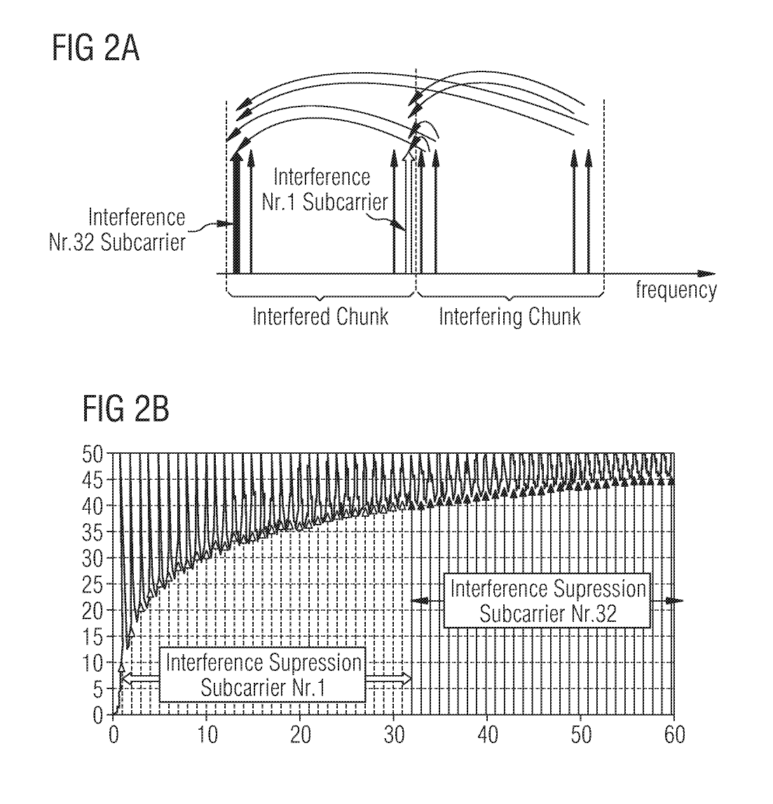

As mentioned hereinabove, the current solution to reduce ICI in radio communications systems such as the one described in FIG. 1, is not efficient as sub-carriers are left unused and consequently the capacity of radio communications system 1000 is reduced. Furthermore, ICI depends also on the distance between the corresponding sub-carrier of the interfered chunk to the interfering chunk. As shown in FIGS. 2a and 2b, the sub-carrier located next to the interfering chunk suffers significantly more from the distortion than the sub-carrier located the farthest away from the interferer. This leads to an unequal ICI distribution within the portion or chunk of allocated spectrum. A sub-carrier located within the interfered chunk which is next to the interfering chunk, suffers more distortion due to ICI as the distance between them is very small, than a sub-carrier located away from the interfering chunk. FIG. 2a shows how the different sub-carriers of the interfering spectrum portion affect sub-carriers in the interfered spectrum portion, while FIG. 2b, shows the amount of ICI that is applied on the different sub-carriers of the interfered spectrum portion or chunk. As mentioned hereinabove, it is assumed for illustrative purposes only, that radio communications system 1000 has a typical available bandwidth of 80 MHz wherein an effective number of 1024 sub-carriers are used, each with a sub-carrier spacing of 78.125 KHz, thus forming chunks or portions comprising of 32 sub-carriers.

FIG. 3, depicts a flowchart indicating the steps implemented by the proposed technique. When at least one transmission is to be made between at least one user equipment 1 and at least one access point 10, a portion of an available spectrum is allocated in step 1 for the at least one transmission. The allocated portion (or chunk) comprises of a plurality of adjacent (or neighbouring) sub-carriers. The number of sub-carriers can depend on different parameters such as the type of transmission being effected, i.e. if the transmission is an audio data or a multimedia data, the amount of data being transmitted, the number of user equipments 1 communicating with an access point 10 etc.

Upon allocation of the portion of spectrum for the at least one transmission, the at least one transmission is error protected in step 2. The error protection is distributed in an unequal manner over the allocated portion of spectrum used for the at least one transmission. Upon completion of the error protection, the at least one transmission is transmitted in step 3.

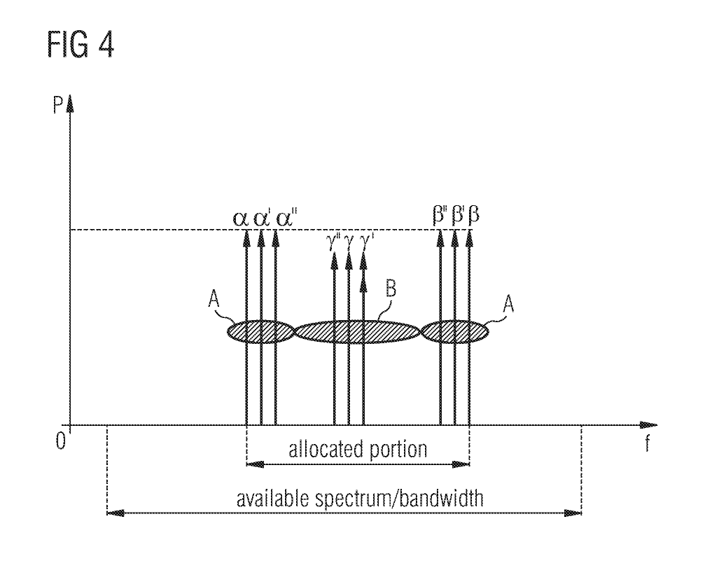

FIG. 4, shows the unequal manner distribution of the error protection. For ease of understanding of the proposed technique, FIG. 4 shows one portion (or chunk) of allocated spectrum. However it is clear to any person skilled in the art that additional portions can be allocated which can neighbour or not the depicted allocated portion.

As mentioned hereinabove, in the illustrative example, the allocated portion comprises of 32 sub-carriers, not all of which are depicted in FIG. 4, for reasons of clarity and ease of understanding. The allocated portion is bounded at on either side by sub-carriers α and β, which lie, respectively, on an lower and an upper sub-carrier frequency of the allocated portion, while a sub-carrier γ, lies on a middle frequency of the allocated portion.

According to the proposed technique, the unequal error protection comprises of implementing a stronger error protection for sub-carriers of the allocated portion that lie at an edge of the allocated portion compared to the error protection implemented for sub-carriers lying around a middle part of the allocated portion. The error protection is effected in this manner, because ICI and consequently burst errors, are greater at the edges (or borders) of the allocated chunk than around the middle part of the chunk.

This is shown in FIG. 4 wherein, hatched areas A and B indicate the different error protection implemented. As can be seen sub-carriers lying at the edges of the allocated portion are error protected within hatched area A, while sub-carriers lying around the middle part of the allocated portion are error protected within hatched area B. Sub-carriers α and β which form the boundaries of the allocated portion lie within hatched area A and will have a stronger error protection than sub-carrier y which lies in hatched area B.

Naturally, as ICI can affect numerous sub-carriers, sub-carriers lying at the edge of the allocated portion are error protected and not just α and β which form the borders of the allocated portion. This is due to the fact that during the transmission between the access point 10 and the user equipment 1, the data that is transmitted is spread across the sub-carriers that form the portion allocated. In this way a depth of error protection is achieved for the data and the effects of ICI are compensated. The number of sub-carriers lying at the edge that are error protected depends on different parameters, such as the type of data to be transmitted, a quality of service parameter indicating an importance of the data, the number of user equipments 1 actively transmitting at a particular time instant etc. This is illustrated in FIG. 4 by sub-carriers α′, α″, β′ and β″. The same applies for sub-carriers lying around the middle part of the portion allocated. This is illustrated in FIG. 4 by sub-carriers y′ and y″. Also the number of sub-carriers lying at the edge that are error protected can depend on a distortion suffered by the sub-carriers or on a predefined value of a suppression rate.

As mentioned hereinabove, during the transmission data is spread over the sub-carriers comprised within the allocated portion. In practise, due to the strong protection applied at the edges A of the portion, the number of sub-carriers lying within area A will be smaller than those lying in area B, as the strong protection reduces the data rate on those sub-carriers and a large number of sub-carriers assigned to area A would lead to a reduction of the efficiency of the allocated radio spectrum. In order to achieve the maximum efficiency from the allocated radio spectrum, all sub-carriers are used for data transmission.

In a further refinement of the proposed technique, it is also possible not to use all the sub-carriers for data transmission, but depending on the amount of data to be transmitted or the anticipated and/or the existing ICI situation or other parameters, taken singly or in combination, to use a plurality of them and apply the technique on the selected sub-carriers. The efficiency might be reduced somewhat however, the amount of processing required is reduced as is the amount of transmit power necessary for the transmission.

The error protection that is applied to the at least one transmission comprises of a combination of a plurality of coding schemes and/or a plurality of modulation schemes. In an alternative embodiment the error protection comprises of one coding scheme and/or a plurality of modulation schemes.

In the above embodiments, at least two modulation schemes are used at any one time during the execution of the error protection. The combination of modulation scheme and/or coding scheme is based on an anticipated and/or an existing ICI situation around an access point 10 and/or a user equipment 1.

The modulation schemes comprise of at least the following modulation schemes: a QAM (quadrature amplitude modulation) scheme, a BPSK (binary phase-shift keying) modulation scheme, a PSK (phase-shift keying) modulation scheme. The coding schemes comprise of at least one of the following coding schemes: a rank distance code, a Reed-Solomon code.

Rank codes are constructed over extended fields GF(2^{m}). In these codes, the length of the code (i.e. the number of output bits) is defined as n, the message length of the code (i.e. the number of input bits) as k and the minimum distance between code words as d. Such codes are usually expressed in the form (n, k, d). In such codes there exists a maximal distance rank code with d=n−k+1. The number of code words that can be generated by such codes is given by the formula 2^{(mk)}. Each such code word can be represented by a matrix with binary entries having a size of m*n. When a (n, k, d) rank code is considered then each non-zero code matrix has a rank of at least d. This allows the correction of any pattern of errors t located within any s rows and r columns of a matrix provided that t=s+r<d/2=(n+k+1)/2.

By constructing a rank code with a size of 2 m, 4 m etc., it is possible to correct respectively the 2, 4 etc. outer-most sub-carriers, that is those sub-carriers lying around the edge of the allocated chunk of spectrum, from burst errors caused by ICI. Thus, in relation to FIG. 4, sub-carriers α, α′, β and β′ can be protected when using a 2 m sized rank code, or α, α′, α″, a′″, β, β′, β″, β′″ when using a 4 m sized rank code and so on depending on the amount of protection required. The choice of size for the rank code depends on the anticipated and/or the existing ICI situation around an access point 10 and/or a user equipment 1.

Access point 10 and/or user equipment 1, measure the strength of received transmissions, the number of errors, such as burst errors, detected in the received transmissions and generate statistics. The values of the measurements are then compared with, for example, pre-defined thresholds which indicate the size of the rank code to be chosen and by extension the number of sub-carriers that are protected. Additionally, access node 10 measures and takes into account the number of user equipments 1 that are present and communicating with it, when choosing the size of the code to be implemented. Similarly, to the abovementioned rank codes, Reed-Solomon codes can also be used to protect transmissions from ICI along the same lines.

In one illustrative embodiment one coding scheme is used for the whole allocated portion of spectrum. In another embodiment a plurality of coding schemes are used, wherein for example, rank codes are used to protect sub-carriers lying at the edge of the allocated portion of spectrum, i.e. sub-carriers α, α′, β, β′ etc, while Reed-Solomon codes are used to protect sub-carriers lying around a middle part of the allocated portion of spectrum, i.e. sub-carriers γ, γ′, γ″. When using a plurality of coding schemes, both access point 10 and/or user equipment 1 use abovementioned values and thresholds in order to determine the size of code to be chosen as well as the number of coding schemes to be used.

As mentioned hereinabove, the modulation schemes used by the technique comprise of at least the following modulation schemes: QAM, BPSK, PSK. In one embodiment, for example, sub-carriers at the edges of the allocated portion of spectrum use BPSK while the ones lying around the middle part of the portion use 16-QAM. In another embodiment, sub-carriers at the edges of the allocated portion of spectrum use BPSK while the ones lying around the middle part of the portion use 8-PSK. In a further embodiment, sub-carriers at the edges of the allocated portion of spectrum use 8-PSK while the ones lying around the middle part of the portion use 16-QAM. At least two modulation schemes are used at any one time in combination, in order to provide the error protection for the transmission.

A user equipment 1 and/or an access point 10, choose the combination of modulation schemes to be used based upon measured and/or predicted SINR (signal-to-interference plus noise ratio) level. Access point 10 and/or user equipment 1, measure the SINR of received transmissions detected in the received transmissions and generate statistics. From these statistics, access point 10 and user equipment 1 generate values for the predicted SINR that will affect transmissions. The values of the measurements are then compared with, for example, pre-defined thresholds which indicate the type and combination of modulation schemes to be used and on which sub-carriers the modulation schemes are to be applied.

In a further refinement of the above embodiments when combining modulation schemes and/or coding schemes, unequal distribution of the transmission power used is also implemented. Sub-carriers lying at the edge of the allocated portion of spectrum are assigned a higher transmit power than sub-carriers lying around a middle part of the allocated portion of spectrum. This is done in order to compensate for the higher ICI present at the edges of the allocated portion. With reference to FIG. 4, sub-carriers lying within hatched area A, for example sub-carriers α, α′, β, β′ etc, are transmitted at a higher transmit power than those lying within hatched area B. In yet a further refinement, it is also possible to individually select sub-carriers that are to be assigned a higher transmit power, for example assigning a higher transmit power to sub-carriers α and β that lie on the border of the allocated portion of spectrum. This can be done for example when the measured and/or anticipated ICI is low, the number of burst errors detected is low or when transmissions are effected over sub-carriers that are not close to each other.

FIG. 5, shows in block diagram form an illustrative implementation of an access point 10 configured to execute the technique. Access point 10 can be at least one of the following: a base station, a base station including a base station controller, a radio network controller.

Access point 10 comprises an allocating unit 100 arranged to allocate at least one portion of an available spectrum (or bandwidth) for at least one transmission, wherein the allocated portion comprises of a plurality of adjacent sub-carriers. Allocating unit 100 is coupled to an error protecting unit 200 arranged to error protect the at least one transmission from access point 10 to at least one user equipment 1. Error protecting unit 200 is further arranged to distribute the error protection in an unequal manner throughout the allocated portion of available spectrum used for the at least one transmission. Once the at least one transmission has been error protected, a transceiver 300 is arranged to transmit it. The transceiver 300 is also further arranged to receive transmissions from user equipments 1.

In order to achieve the unequal error protection of the at least one transmission, the error protecting unit 200 is further arranged to implement a stronger error protection for sub-carriers lying at an edge of the allocated portion of available spectrum than for sub-carriers lying around a middle part of the allocated portion.

Error protecting unit 200 is further adapted to combine a plurality of coding schemes and/or a plurality of modulation schemes when error protecting the at least one transmission in order to implement the unequal error protection. Error protecting unit 200 can be hardware implemented in one or more processors, in such a manner that as to form one unit combining the functionality of coding and modulating the error protection or alternatively error protecting unit 200 can comprise of separately coupled hardware units implementing coding unit 210 and modulating unit 220. In both examples error protecting unit 200 is coupled to a control unit 500 which are arranged to control error protecting unit 200 and also access point 10. In an alternative embodiment the error protection unit 200 is arranged to combine one coding scheme and/or a plurality of modulation schemes.

In the above embodiments, at least two modulation schemes are used at any one time during the execution of the error protection. The combination of modulation scheme and/or coding scheme is based on an anticipated and/or an existing ICI situation around access point 10. Error protecting unit 200 (or in an alternative embodiment modulating unit 220) is further arranged to use modulation schemes that comprise of at least the following modulation schemes: a QAM scheme, a BPSK scheme, a PSK scheme. Error protecting unit 200 (or in an alternative embodiment coding device 210) is further arranged to use coding schemes that comprise of at least one of the following coding schemes: a rank distance code, a Reed-Solomon code.

Control unit 500 is further adapted to measure and/or predict SINR detected in transmissions received via transceiver 300, and generate statistics. From these statistics, the control unit is further adapted to generate values for the predicted SINR that will affect transmissions. Control unit 500 is further arranged to compare these values with, for example, pre-defined thresholds which indicate the type and combination of modulation schemes to be used and on which sub-carriers the modulation schemes are to be applied. The pre-defined thresholds are stored locally within control unit 500 or can be transmitted from a central network management device to access point 10 upon request from control unit 500. Control unit 500 is further adapted to provide error protecting unit 200 or modulating unit 220 with information resulting from the comparison enabling error protecting unit 200 or modulating unit 220 to use the appropriate modulation schemes.

As mentioned hereinabove, the modulation schemes used by the technique comprise of at least the following modulation schemes: QAM, BPSK, PSK. In one embodiment, the error protecting unit 200 or modulating device 220 is arranged to use, for example, BPSK for sub-carriers at the edges of the allocated portion of spectrum while for sub-carriers lying around the middle part of the portion they use 16-QAM. In another embodiment, the error protecting unit 200 or modulating device 220 is arranged to use BPSK for sub-carriers at the edges of the allocated portion of spectrum while for sub-carriers lying around the middle part of the portion 8-PSK is used. In a further embodiment, error protecting unit 200 or modulating device 220 is arranged to use 8-PSK for sub-carriers at the edges of the allocated portion of spectrum while for ones lying around the middle part of the portion 16-QAM is used.

Control unit 500 is further arranged to measure the strength of received transmissions, the number of errors, such as burst errors, detected in the received transmissions, the number of user equipments 1 present and in communication with it, and to generate statistics. The values of the measurements are then compared with, for example, pre-defined thresholds, as mentioned above, which indicate the size of the code, such as a rank code or a Reed-Solomon code, to be chosen and by extension the number of sub-carriers that are protected. Control unit 500 is further adapted to provide error protecting unit 200 or coding device 210 with information resulting from the comparison enabling the error protecting unit 200 or the coding device 210 to use coding schemes with the appropriate size for the required protection.

In one illustrative embodiment the error protecting unit 200 or the coding device 210 is further arranged to use one coding scheme for the whole allocated portion of spectrum. In another embodiment the error protecting unit 200 or the coding device 210 is further arranged to use a plurality of coding schemes, wherein for example, rank codes are used to protect sub-carriers lying at the edge of the allocated portion of spectrum, i.e. sub-carriers α, α′, β, β′ etc, while Reed-Solomon codes are used to protect sub-carriers lying around a middle part of the allocated portion of spectrum, i.e. sub-carriers γ, γ′, γ″.

In a further refinement of the above embodiments when combining modulation schemes and/or coding schemes, unequal distribution of the transmission power used is also implemented. Sub-carriers lying at the edge of the allocated portion of spectrum are assigned a higher transmit power than sub-carriers lying around a middle part of the allocated portion of spectrum. This is done in order to compensate for the higher ICI present at the edges of the allocated portion. For example, with reference to FIG. 4, sub-carriers lying within hatched area A, for example sub-carriers α, α′, β, β′ etc., are transmitted at a higher transmit power than those lying within hatched area B. In yet a further refinement, it is also possible to individually select sub-carriers that are to be assigned a higher transmit power, for example assigning a higher transmit power to sub-carriers α and β that lie on the border of the allocated portion of spectrum. This can be done for example when the measured and/or anticipated ICI is high, the number of burst errors detected is large or when transmissions are effected over sub-carriers that are not close to each other.

The unequal power distribution is effected when, after error protection, the at least one transmission is ready to be transmitted by the transceiver 300. At that point, the control unit 500, is further arranged to instruct transmit power controller 400 to assign a certain transmit power value for the transmission of certain sub-carriers and another transmit power value for other sub-carriers.

In the abovementioned embodiments, the transceiver 300 is further arranged to transmit a message, such as a broadcast message over a broadcast channel, indicating the allocation of the portion (or chunk) of the available spectrum or the allocations of chunks, once allocating unit 100 has performed the allocation. This broadcasted message enables user equipments 1 that do not have the ability to allocate portions of available spectrum themselves, to receive it and then use the allocation indicated when transmitting.

Transceiver 300 is also further arranged, in the event that a plurality of user equipments 1 are present and transmitting to access point 10, to further include in the message a portion to user equipment designation, for example a user equipment identifier with a specific allocated portion. This is advantageous when a plurality of user equipments do not have the ability to allocate portions of available spectrum themselves, and in this way they are able to transmit without danger of causing or suffering ICI from user equipments using sub-carriers allocated in neighbouring portions or of using identical portions. Transceiver 300 is also further arranged to transmit a message indicating the allocation of the portion (or chunk) of the available spectrum once allocating unit 100 has performed the allocation, over a dedicated channel to a user equipment 1 so that the user equipment 1 is made aware of what portion of the spectrum it has to use and what protection techniques it has to apply.

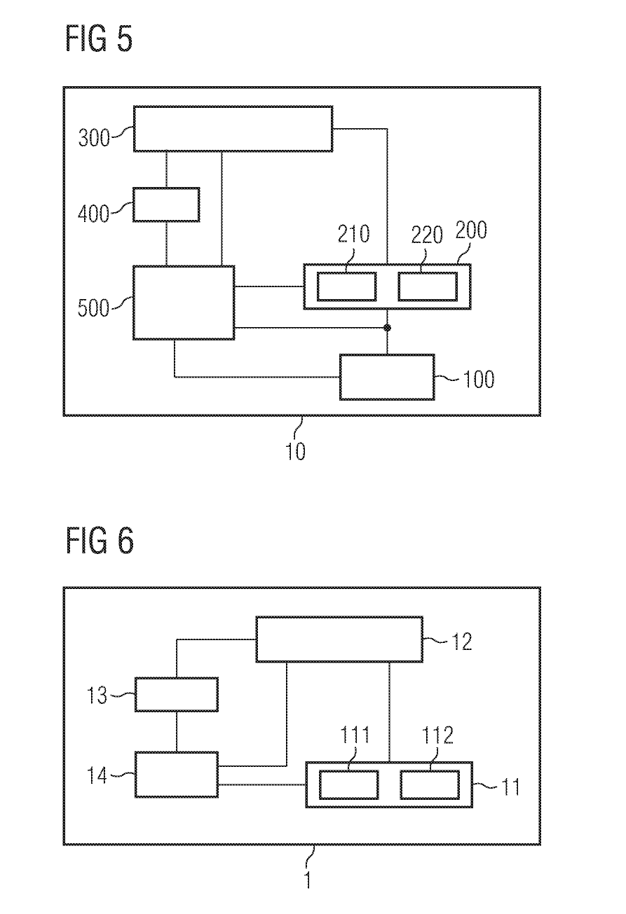

FIG. 6, shows in block diagram form an illustrative implementation of an user equipment 1 having devices arranged to execute the technique.

User equipment 1 has a transceiver unit 12 arranged to receive a message from the at least one access point 10 over a channel such as a broadcast channel or a dedicated channel, the received message indicating an allocation of at least one portion of an available spectrum for the at least one data transmission made by the at least one access point 10, the at least one portion comprising of a plurality of adjacent sub-carriers. Transceiver unit 12 is coupled to error protecting unit 11 arranged to error protect the at least one transmission from user equipment 1 to at least one access point 10. The error protecting unit 11 is further arranged to distribute the error protection in an unequal manner throughout the allocated portion of available spectrum used for the at least one transmission. Once the at least one transmission has been error protected, transceiver unit 12 is arranged to transmit it to the at least one access point 10. In order to achieve the unequal error protection of the at least one transmission, the error protecting unit 11 is further arranged to implement a stronger error protection for sub-carriers lying at an edge of the allocated portion of available spectrum than for sub-carriers lying around a middle part of the allocated portion.

The error protecting unit 11 is further adapted to combine a plurality of coding schemes and/or a plurality of modulation schemes when error protecting the at least one transmission in order to implement the unequal error protection. The error protecting unit 11 can be hardware implemented in one or more processors, in such a manner that as to form one unit combining the functionality of coding and modulating the error protection or alternatively the error protecting unit 11 can comprise of separately coupled hardware units implementing coding unit 111 and modulating unit 112. In both examples the error protecting unit 11 is coupled to control unit 14 which is arranged to control the error protecting unit 11 and also user equipment 1. In an alternative embodiment the error protection unit 11 is arranged to combine one coding scheme and/or a plurality of modulation schemes.

In the above embodiments, at least two modulation schemes are used at any one time during the execution of the error protection. The combination of modulation scheme and/or coding scheme is based on an anticipated and/or an existing ICI situation around user equipment 1. The error protecting unit 11 (or in an alternative embodiment modulating unit 112) is further arranged to use modulation schemes that comprise of at least the following modulation schemes: a QAM scheme, a BPSK scheme, a PSK scheme. The error protecting unit 11 (or in an alternative embodiment coding unit 111) is further arranged to use coding schemes that comprise of at least one of the following coding schemes: a rank distance code, a Reed-Solomon code.

The control unit 14 is further adapted to measure and/or predict SINR detected in transmissions received via the transceiver unit 12, and generate statistics. From these statistics, the control unit 14 is further adapted to generate values for the predicted SINR that will affect transmissions. The control unit 14 is further arranged to compare these values with, for example, pre-defined thresholds which indicate the type and combination of modulation schemes to be used and on which sub-carriers the modulation schemes are to be applied. The pre-defined thresholds are stored locally within the control unit 14. The control unit 14 is further adapted to provide the error protecting unit 11 or modulating unit 112 with information resulting from the comparison enabling the error protecting unit 11 or modulating unit 112 to use the appropriate modulation schemes.

As mentioned hereinabove, the modulation schemes proposed by the inventors have at least the following modulation schemes: QAM, BPSK, PSK. In one embodiment, the error protecting unit 11 or modulating unit 112 is arranged to use, for example, BPSK for sub-carriers at the edges of the allocated portion of spectrum while for sub-carriers lying around the middle part of the portion they use 16-QAM. In another embodiment, the error protecting unit 11 or modulating unit 112 is arranged to use BPSK for sub-carriers at the edges of the allocated portion of spectrum while for sub-carriers lying around the middle part of the portion 8-PSK is used. In a further embodiment, the error protecting unit 11 or modulating unit 112 is arranged to use 8-PSK for sub-carriers at the edges of the allocated portion of spectrum while for ones lying around the middle part of the portion 16-QAM is used.

The control unit 14 is further arranged to measure the strength of received transmissions, the number of errors, such as burst errors, detected in the received transmissions and to generate statistics. The values of the measurements are then compared with, for example, pre-defined thresholds, as mentioned above, which indicate the size of the code, such as a rank code or a Reed-Solomon code, to be chosen and by extension the number of sub-carriers that are protected. The control unit 14 is further adapted to provide the error protecting unit 11 or coding unit 111 with information resulting from the comparison enabling the error protecting unit 11 or coding unit 111 to use coding schemes with the appropriate size for the required protection.

In one illustrative embodiment the error protecting unit 11 or coding unit 111 is further arranged to use one coding scheme for the whole allocated portion of spectrum. In another embodiment the error protecting unit 11 or coding unit 111 is further arranged to use a plurality of coding schemes, wherein for example, rank codes are used to protect sub-carriers lying at the edge of the allocated portion of spectrum, i.e. sub-carriers α, α′, β, β′ etc, while Reed-Solomon codes are used to protect sub-carriers lying around a middle part of the allocated portion of spectrum, i.e. sub-carriers γ, γ′, γ″.

In a further refinement of the above embodiments when combining modulation schemes and/or coding schemes, unequal distribution of the transmission power used is also implemented. Sub-carriers lying at the edge of the allocated portion of spectrum are assigned a higher transmit power than sub-carriers lying around a middle part of the allocated portion of spectrum. This is done in order to compensate for the higher ICI present at the edges of the allocated portion. For example, with reference to FIG. 4, sub-carriers lying within hatched area A, for example sub-carriers α, α′, β, β′ etc, are transmitted at a higher transmit power than those lying within hatched area B. In yet a further refinement, it is also possible to individually select sub-carriers that are to be assigned a higher transmit power, for example assigning a higher transmit power to sub-carriers α and β that lie on the border of the allocated portion of spectrum. This can be done for example when the measured and/or anticipated ICI is low, the number of burst errors detected is low or when transmissions are effected over sub-carriers that are not close to each other.

The unequal power distribution is effected when, after error protection, the at least one transmission is ready to be transmitted by the transceiver unit 12 At that point, the control unit 14 is further arranged to instruct transmit power controller 13 to assign a certain transmit power value for the transmission of certain sub-carriers and another transmit power value for other sub-carriers.

In the event that a user equipment 1 receives a message over a broadcast channel from an access point 10, the message received indicating a portion allocation made by the access point 10, user equipment 1 is further adapted to use the allocation provided by the access point 10. If however no such message is received, user equipment 1, will allocate a portion of available spectrum as already explained hereinabove. If such a message is received after user equipment 1 has already allocated a portion, then for the at least one transmission being effected, the allocation made by user equipment 1 is kept. After the end of the at least one transmission, the allocation received in the message is used by user equipment 1.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A method of transmitting at least one data transmission between at least one first radio station and at least one second radio station in a radio communications system, comprising:
allocating at least one portion of an available spectrum for said at least one data transmission, said at least one portion including a plurality of adjacent sub-carriers;
error protecting said at least one data transmission, the error protecting being distributed in an unequal manner throughout said at least one portion of said available spectrum allocated for said at least one data transmission; and
transmitting said at least one data transmission upon completion of said error protection.

15. The method according to claim 14, wherein said unequal distribution of said error protection includes implementing a stronger error protection for sub-carriers of said at least one portion lying at an edge of said at least one portion than for sub-carriers lying about a middle part of said at least one portion.

16. The method according to claim 14, wherein said error protection includes a combination of a plurality of coding schemes and/or a plurality of modulation schemes.

17. The method according to claim 16, wherein at least two modulation schemes of said plurality of modulation schemes are used at any one time in said combination.

18. The method according to claim 14, wherein said plurality of modulation schemes include at least one of a quadrature amplitude modulation scheme, a phase-shift keying modulation scheme, and a binary phase-shift keying modulation scheme.

19. The method according to claim 16, wherein at least one of said coding schemes includes at least one of a rank distance code and a Reed-Solomon code.

20. The method according to claim 14, wherein said transmitting said at least one data transmission further includes unequally distributing a transmit power over said at least one portion of said available spectrum used to transmit said at least one data transmission.

21. The method according to claim 20, wherein said unequal distribution of said transmit power includes assigning a higher transmit power for sub-carriers of said at least one portion of said available spectrum lying at an edge of said at least one portion than for sub-carriers lying about a middle part of said at least one portion.

22. The method according to claim 14, wherein at least an orthogonal frequency division multiple access technique is used to transmit said at least one data transmission.

23. An access point including a transmission unit transmitting at least one data transmission between said access point and at least one user equipment in a communications system, comprising:
an allocation unit allocating at least one portion of an available spectrum for said at least one data transmission, said at least one portion of said available spectrum including a plurality of adjacent sub-carriers;
an error protecting unit error protecting said at least one data transmission and distributing said error protection in an unequal manner throughout said at least one portion allocated for said at least one data transmission; and
a transceiver transmitting said at least one data transmission upon completion of said error protection.

24. The access point according to claim 23, wherein said access point is at least one a base station, a base station including a base station controller, and a radio network controller.

25. A user equipment including a transmitter transmitting at least one data transmission between said user equipment and at least one access point in a communications system, comprising:
a transceiver receiving a message from said at least one access point over a channel, said message indicating an allocation of at least one portion of an available spectrum for said at least one data transmission, said at least one portion including a plurality of adjacent sub-carriers;
an error protecting unit error protecting said at least one data transmission and distributing said error protection in an unequal manner throughout said at least one portion allocated for said at least one data transmission; and
a transmitter transmitting said at least one data transmission upon completion of said error protection.

26. The user equipment according to claim 25, wherein said user equipment is a mobile station.

27. A radio communications system, comprising:
at least one access point allocating at least one portion of an available spectrum for at least one data transmission, the at least one portion of the available spectrum including a plurality of adjacent sub-carriers, error protecting the at least one data transmission and distributing the error protection in an unequal manner throughout the at least one portion allocated for the at least one data transmission, and transmitting the at least one data transmission upon completion of the error protection; and
at least one user equipment receiving a message from the at least one access point over a channel, the message indicating the allocation of the at least one portion of the available spectrum for the at least one data transmission, error protecting the at least one data transmission and distributing the error protection in an unequal manner throughout the at least one portion allocated for the at least one data transmission, and transmitting the at least one data transmission upon completion of the error protection.

28. A method of transmitting at least one data transmission between at least one first radio station and at least one second radio station, comprising:
allocating at least one portion of an available spectrum for the at least one data transmission, the at least one portion including a plurality of adjacent sub-carriers;
assigning a higher transmit power to sub-carriers lying at an edge of the allocated portion of the spectrum than to sub-carriers lying at a non-edge part of the allocated portion of the spectrum; and
transmitting the at least one data transmission having the assigned higher and lower transmit powers for the sub-carriers.
